(19) United States
(12) Patent Application Publication
(10) Pub. No.: US 2016/0298829 A1
(43) Pub. Date: Oct. 13, 2016

(54) SYSTEM AND METHOD FOR CONTROLLING LIGHT OUTPUT IN A LED LUMINAIRE

(71) Applicants: Pavel JURIK, Prostredni Becva (CZ); Josef Valchar, Prostredni Becva (CZ)

(72) Inventors: Pavel JURIK, Prostredni Becva (CZ); Josef Valchar, Prostredni Becva (CZ)

(21) Appl. No.: 14/682,834

(22) Filed: Apr. 9, 2015

(51) Int. Cl. F21V 14/02; F21V 21/15

(52) U.S. Cl. CPC F21V 14/02; F21V 21/15; F21Y 2105/005

(57) ABSTRACT

Described is a method for controlling the beam angle of individual lighting devices in luminaires, specifically to a method relating to providing the coordinated control of the beam spread of LEDs in a wash light. The LEDs may be mounted in a plurality of modules. The LED may be in a linear arrangement in a module. The LEDs may be mounted in a plurality of modules that are arrayed in a two dimensional array. The LEDs in the linear arrangement form modular groups where the beam angle of each modular group may be controlled independent of other modular groups.

### RELATED APPLICATION(S)

Utility applications based on this provisional application may also claim priority as a continuation applications for utility applications filed claiming priority of provisional application 61/950,403 filed on 10 Mar. 2015.

### TECHNICAL FIELD OF THE INVENTION

The present invention generally relates to a method for controlling the beam angle of individual lighting devices in luminaires, specifically to a method relating to providing the coordinated control of the beam spread of LED modules in a wash light.

### BACKGROUND OF THE INVENTION

Luminaires with automated and remotely controllable functionality are well known in the entertainment and architectural lighting markets. Such products are commonly used in theatres, television studios, concerts, theme parks, night clubs and other venues. A typical product will provide control over the functions of the luminaire allowing the operator to control the intensity and color of the light beam from the luminaire that is shining on the stage or in the studio. Many products also provide control over other parameters such as the position, focus, beam size, beam shape and beam pattern. In such products that contain light emitting diodes (LEDs) to produce the light output it is common to use more than one color of LEDs and to be able to adjust the intensity of each color separately such that the output, which comprises the combined mixed output of all LEDs, can be adjusted in color. For example, such a product may use red, green, blue, and white LEDs with separate intensity controls for each of the four types of LED. This allows the user to mix almost limitless combinations and to produce nearly any color they desire.

FIG. 1 illustrates a typical multiparameter automated luminaire system 10. These systems typically include a plurality of multiparameter automated luminaires 12 which typically each contain on-board a light source (not shown), light modulation devices, electric motors coupled to mechanical drives systems and control electronics (not shown). In addition to being connected to mains power either directly or through a power distribution system (not shown), each luminaire is connected is series or in parallel to data link 14 to one or more control desks 15. The luminaire system 10 is typically controlled by an operator through the control desk 15.

A known arrangement for luminaires used in the entertainment or architectural market is that of a wash light or cyclorama light. Such luminaires may be constructed as automated luminaires where the operator has remote control of the output angle of the emitted light. It is well known to design the optical systems of such automated luminaires such that the output angle of the emitted light beam can be adjusted over a range of values, from a very narrow beam to a wide beam. This beam angle size, or zoom, range allows the lighting designer full control over the size of a projected image, pattern or wash area.

In recent years many manufacturers have moved to using LEDs as the light sources in such luminaires, and it has become common to use multiple individual LED sources arranged in an array. The Robe Lighting CitySkape 48 is an example of such a luminaire with an array of 48 LEDs arranged as 12 light modules each containing a red, green, blue, and white LED. It is possible with such an LED luminaire to change the beam angle of every light module together using a single mechanism. For example, the Robe Lighting Robin 600 LED Wash contains 37 LED light modules which may be simultaneously altered in beam angle from 15° to 60°. However, none of the prior art examples allow coordinated and separate control of the output angles of the individual light modules. Such ability would be advantageous, as it would allow the combined light beam formed from the mixing of the light output from the LED modules to be shaped and controlled.

There is a need for a method for controlling the output beam angle of LED light modules devices in luminaires, specifically to a method relating to providing the coordinated control of the beam spread of LED modules in a wash light.

### BRIEF DESCRIPTION OF THE DRAWINGS

For a more complete understanding of the present invention and the advantages thereof, reference is now made to the following description taken in conjunction with the accompanying drawings in which like reference numerals indicate like features and wherein:

FIG. 1 illustrates a multiparameter automated luminaire lighting system;

FIG. 2 illustrates an embodiment of a luminaire with a square array of a plurality of light emitting modules;

FIG. 3 illustrates the modular beam angle control system of the light emitting modules in an embodiment illustrated in FIG. 2;

FIG. 4 illustrates a side cross-sectional view an embodiment of the beam angle control system of the light emitting modules in FIG. 3;

FIG. 5 illustrates schematically an embodiment of a beam angle control lens system;

FIG. 6 illustrates additional components of an embodiment of the beam angle control optical system configured for one beam angle;

FIG. 7 illustrates the embodiment of the beam angle control optical system components of FIG. 6 configured for a different beam;

FIG. 8 illustrates an embodiment of a sub-modular effects system;

FIG. 9 illustrates an embodiment of single row light;

FIG. 10 illustrates a further embodiment of the additional components of the beam angle control optical system of FIG. 6;

FIG. 11 illustrates the embodiment of the beam angle control optical system components of FIG. 10 configured to create a different beam angle. c

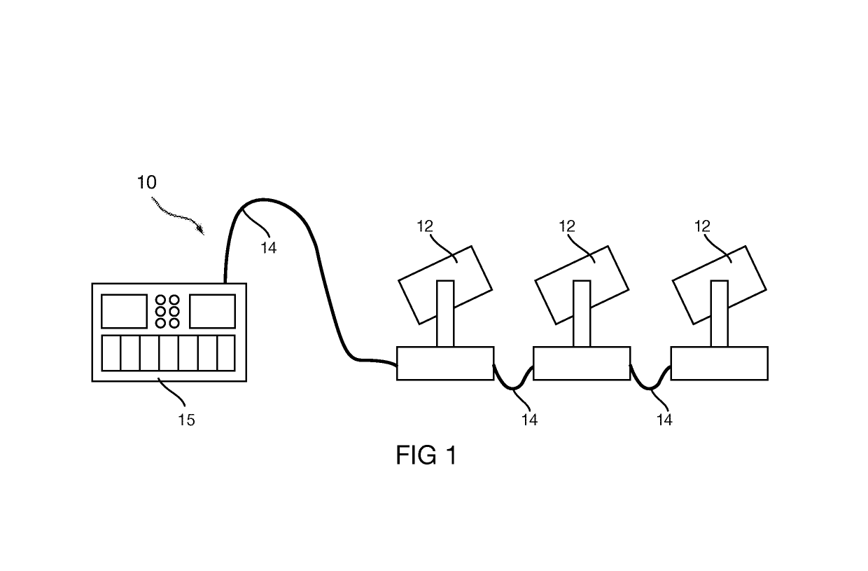

### DETAILED DESCRIPTION OF THE INVENTION

Preferred embodiments of the present invention are illustrated in the FIGUREs, like numerals being used to refer to like and corresponding parts of the various drawings.

The present invention generally relates to a method for controlling the movement of LED devices in luminaires, specifically to a method relating to allowing both synchronized and independent movement of LED lights in a light curtain or other LED luminaires.

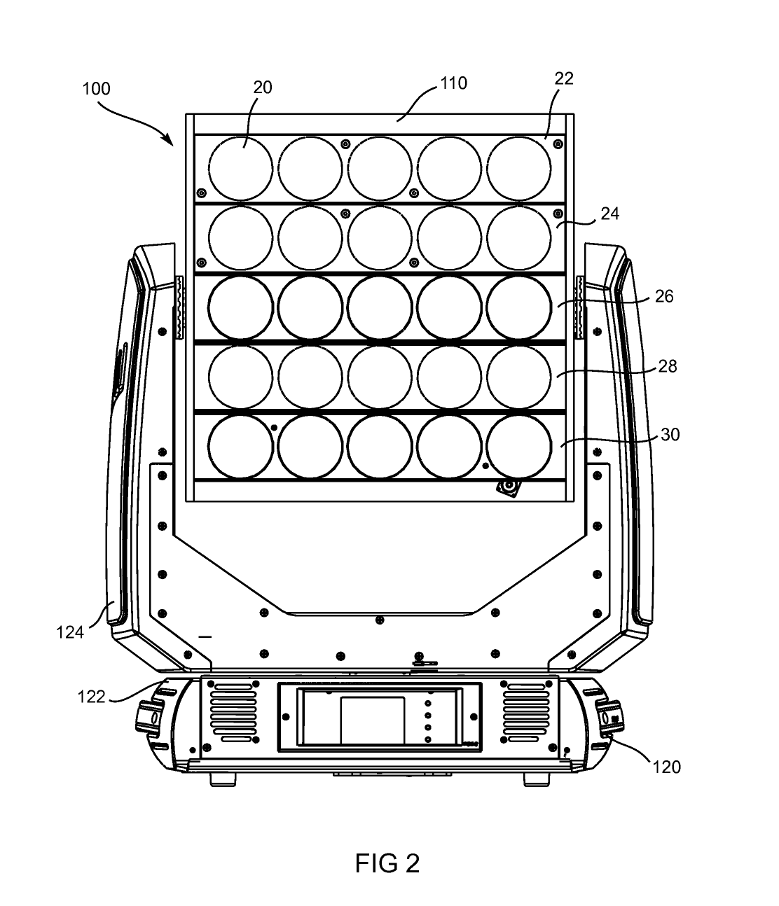

FIG. 2 illustrates an embodiment of a luminaire with modular beam angle control system 100. Luminaire 100 is fitted with a linear array of a plurality of light-emitting modules or assemblies 22, 24, 26, 28 and 30. In the embodiment illustrated 25 light-emitting sub-modules 20 are grouped and mounted within the modules 22, 24, 26, 28 and 30 (five sub-modules per module) forming a square array. The luminaire head 110 that serves as a common carrier to carry the modules 22, 24, 26, 28 and 30 in a side-by-side linear arrangement so that the 25 sub-modules (5 sub-modules per module) form a square arrangement to form a wash luminaire 100. Each light-emitting sub-module 20 emits collimated and controlled light. Each of these light beams may be individually adjusted for color, by adjusting the output mix of its LED emitters. Each module 22, 24, 26, 28, and 30 of row of five light-emitting sub-modules 20. Although a five by five array of light-emitting modules is shown here, the invention is not so limited and any shape or size of array of light-emitting modules may be used.

In the embodiment shown, the luminaire head 110 may be articulated as is well known in the prior art to be capable of a global tilting and panning motion through motors and motor drivers which are controlled by an operator through the communications link. In the embodiment shown the luminaire head 110 may be articulated via gimbal mechanism with a base 122 that can rotate the arms 124 about one axis and arms 124 which can rotate the head 110 about another axis. Other mechanisms for redirecting the light emitted by the head 110 are also contemplated and with the scope.

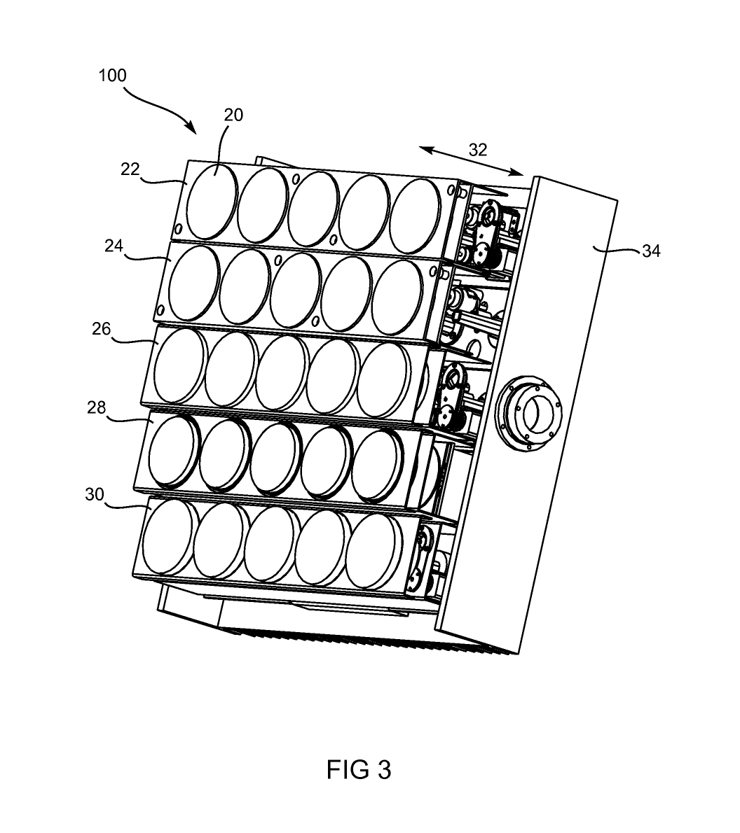

FIG. 3 illustrates the beam angle control system of the light emitting modules in the embodiment illustrated in FIG. 2. Each of the optical modules 22, 24, 26, 28, and 30 mounted in housing 34 is capable of being independently moved in the direction shown by arrow 32. Each optical module 22, 24, 26, 28, and 30 contain lenses or other optical devices designed to alter the beam of the associated LED light-emitting module. The LED light emitting-module is normally fixed to and stationary with respect to the luminaire housing 34 while the optical module move towards and away from the light-emitting sub module(s).

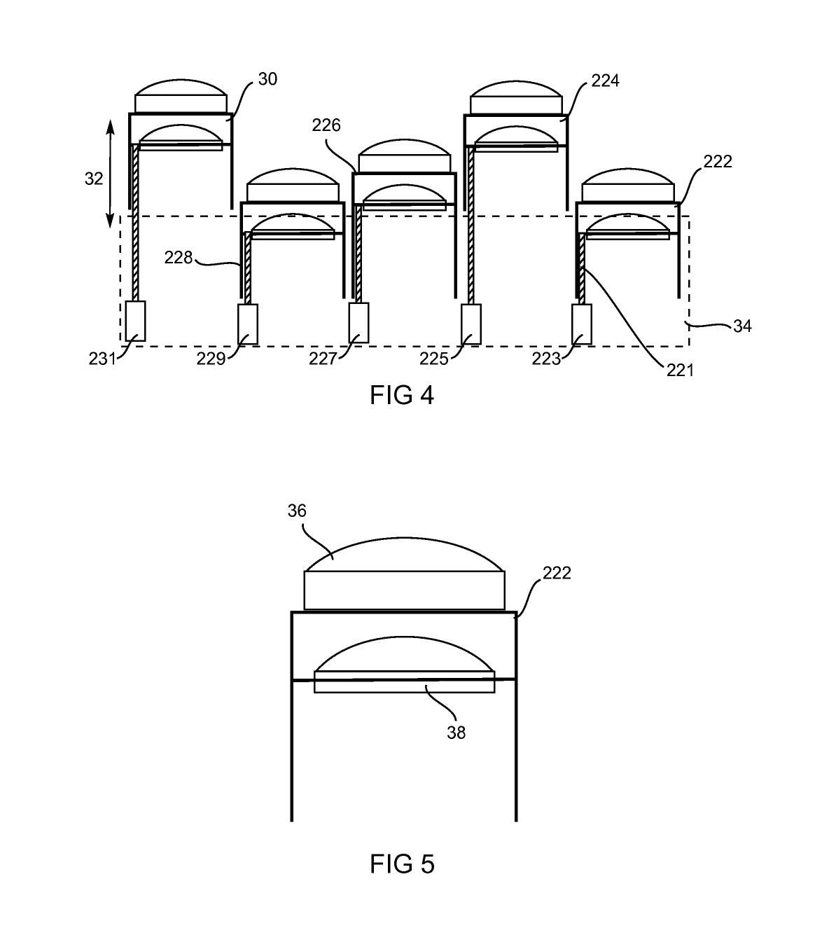

FIG. 4 illustrates schematically a side view of and embodiment of the beam angle control system of the light emitting modules in the luminaire head 110 (not shown in FIG. 4). Optical module angle control system 222 is actuated by motor 223 that is capable of moving optical module angle control system 222 into and out of luminaire housing 34. Similarly motor 225 actuates optical module angle control system 224, motor 227 operates optical module angle control system 226, motor 229 actuates optical module angle control system 228, and motor 231 actuates optical module angle control system 30. Motors 223, 225, 227, 229, and 231 may be stepper motors, servomotors, linear actuators, solenoids, DC motors, or other mechanisms as well known in the art. In the embodiment shown the motors work by driving a worm gear. For example motor 223 drives worm gear 221. Other mechanisms for actuating the desired movement are also contemplated. Although only a single motor and worm gear pair actuator is shown here for each optical module angle control system, in practice an optical module carrier covering a row or plurality of light-emitting modules may utilize more than one actuator operating in coordination to actuate the optical module angle control.

FIG. 5 illustrates schematically the lens system of the light emitting modules in an embodiment of the invention. Optical module angle control system 222 may contain a number of optical assemblies, one for each associated light-emitting sub-module. In the embodiment shown, each optical assembly comprises a first lens 36 and a second lens 38. First lens 36 and second lens 38 are attached to the angle control system 222 and move with it in a fixed relationship to each other. The invention is however not so limited, and further embodiments may contain different numbers and types of lenses or other optical systems as well known in the art. In particular, further embodiments may utilize systems where the relationship of first lens 36 and second lens 38 is not fixed, and can alter. Lenses 36 and 38 may be meniscus lenses, plano convex lenses, bi-convex lenses, holographic lenses, or other lenses as well known in the art.

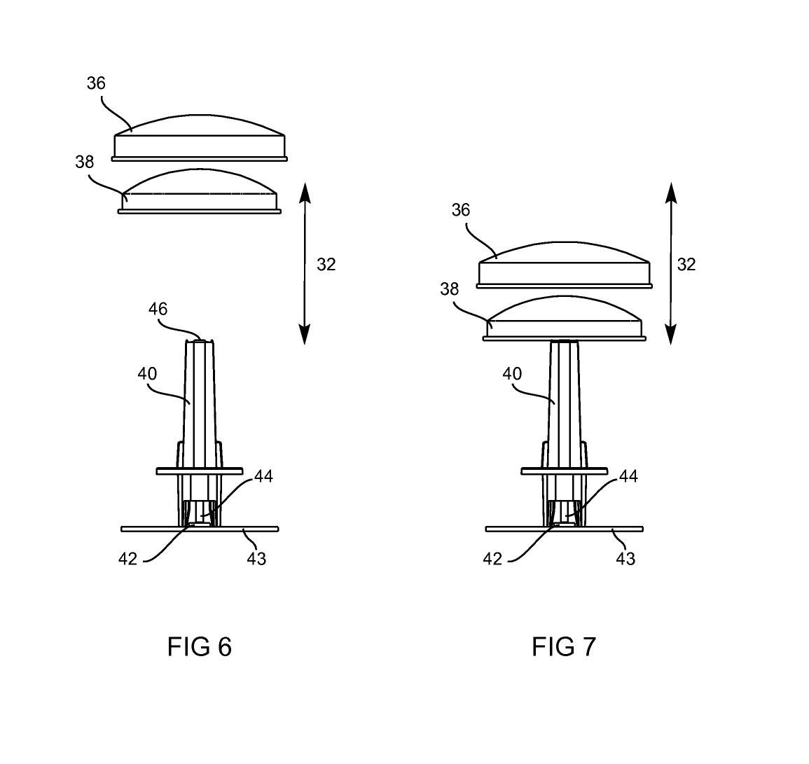

FIG. 6 and FIG. 7 illustrate the operation of the optical system in an embodiment of the invention. A light-emitting module of the system comprises an LED 42, which may include a primary optic, mounted on substrate 43. LED 42 may contain a single color die or may contain multiple dies, each of which may be of common or differing colors. The light output from the dies in LED 42 enters light integrator optic 44 contained within protective sleeve 40. Light integrator 44 may be a device utilizing internal reflection so as to collect, homogenize and constrain and conduct the light to exit port 46. Light integrator 44 may be a hollow tube with a reflective inner surface such that light impinging into the entry port may be reflected multiple times along the tube before leaving at the exit port 46. Light integrator 44 may be a square tube, a hexagonal tube, a heptagonal tube, an octagonal tube, a circular tube, or a tube of any other cross section. In a further embodiment light integrator 44 may be a solid rod constructed of glass, transparent plastic or other optically transparent material where the reflection of the incident light beam within the rod is due to total internal reflection (TIR) from the interface between the material of the rod and the surrounding air. The integrating rod may a square rod, a hexagonal rod, a heptagonal rod, an octagonal rod, a circular rod, or a rod of any other cross section.

The light exiting integrator 44 will be well homogenized with all the colors of LED dies 42 mixed together into a single colored light beam. In various embodiments each LED emitter 42 may comprise a single LED die of a single color or a group of LED dies of the common or differing colors. For example in one embodiment LED emitter 42 may comprise one each of a Red, Green, Blue and White LED die. In further embodiments LED emitter 42 may comprise a single LED chip or package while in yet further embodiments LED emitter 42 may comprise multiple LED chips or packages either under a single primary optic or each package with its own primary optic. In some embodiments these LED die(s) may be paired with optical lens element(s) as part of the LED light-emitting module. In a further embodiment LED emitter 42 may comprise more than four colors of LEDs. For example seven colors may be used, one each of a Red, Green, Blue, White, Amber, Cyan, and Deep Blue/UV LED die.

Integrator 44 may advantageously have an aspect ratio where its length is much greater than its diameter. The greater the ratio between length and diameter, the better the resultant mixing and homogenization will be. Integrator 44 may be enclosed in a tube or sleeve 40 that provides mechanical protection against damage, scratches, and dust.

In further embodiments the light integrator 44, whether solid or hollow, and with any number of sides, may have entry ports and exit ports that differ in shape. For example, a square entry port and an octagonal exit port 46. Further light integrator 44 may have sides which are tapered so that the entrance aperture is smaller than the exit aperture. The advantage of such a structure is that the divergence angle of light exiting the integrator 44 at exit port 46 will be smaller than the divergence angle for light entering the integrator 44. The combination of a smaller divergence angle from a larger aperture serves to conserve the etendue of the system. Thus a tapered integrator 44 may provide similar functionality to a condensing optical system.

Light exiting integrator 44 is directed towards and through first lens 36 and second lens 38 that serve to further control the angle of the emitted light beam. First lens 36 and second lens 38 may be moved as a pair towards and away from light integrator 44 as described above in the direction along the optical axis of the system as shown by arrow 32. In the position shown in FIG. 6 where first lens 36 and second lens 38 are at their furthest separation from the light-emitting module and the exit 46 of integrator 44 the emitted light beam will have a narrow beam angle. In the position shown in FIG. 7 where first lens 36 and second lens 38 are at their closest distance to the light-emitting module and the exit 46 of integrator 44 the emitted light beam will have a wide beam angle. Intermediate positions of the lenses 36 and 38 with respect to exit 46 of integrator 44 will provide intermediate beam angles. In one embodiment of the invention, the range of beam angles from the system may be adjusted from 4° to 50°.

Returning now to FIG. 2, in operation each row of optical modules 22, 24, 26, 28, and 30 may be individually and separately adjusted for beam angle. For example, as shown in FIG. 2, row 30 may be in a wide-angle position, row 28 in a slightly narrower position, row 26 narrower again, while rows 24 and 22 are in the narrowest angle position. Such a configuration may be useful for lighting a cyclorama or backing where row 30, with its wide angle, is lighting areas of the backing that are close to the luminaire, while row 22, with its narrow angle, is lighting areas of the backing that are distant from the luminaire. Such an arrangement will thus provide even and adjustable lighting of the backing.

In further embodiments the operator may be provided with individual control of the light output from the LEDs in each of the light emitting modules 20. In conjunction with the beam angle control afforded by the movement of the optical module carriers this allows interesting and unusual lighting effects to be created.

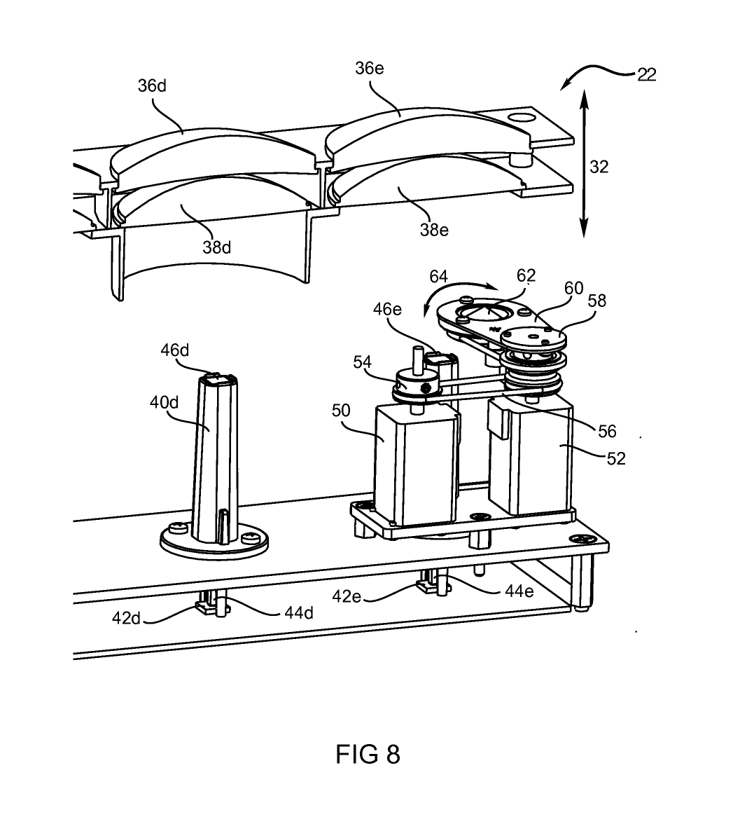

FIG. 8 illustrates an effects system that may be fitted to an embodiment of the invention. This figure shows two adjacent light emitting sub-modules arranged in a row in module 22. The first light emitting sub-module comprises, as previously described, LED 42d, light integrator 44d with exit 46d contained within tube 40d. Associated with this light emitting sub-module are lenses 36d and 38d. The second light-emitting sub-module has the same components as the first, LED 42e, light integrator 44e with exit 46e contained within tube 40e. Associated with this second light-emitting sub-module are lenses 36e and 38e. The second light-emitting sub-module additionally has a lighting effects system. This lighting effects system comprises optical effect 62 that is rotatably mounted in effects carrier arm 60 such that it can rotate as shown by arrow 64. This rotation 64 is effected through motor 50 and pulley system 58. Additionally the effect carrier arm may be swung into and out of position through motor 52, pulley 54, and belt 56. Through operation of motor 52 optical effect 62 may either be positioned across light exit aperture 46e or moved away from light exit aperture 46e and out of the light beam so that it has no effect. Once the effect 62 is in position across the light beam, lenses 36e and 38e may be moved in direction 32 as before to alter the beam angle of the light beam, now further modified by effect 62. Motors 50, and 52 may be stepper motors, servomotors, linear actuators, solenoids, DC motors, or other mechanisms as well known in the art.

Effect 62 may be a prism, effects glass, gobo, gobo wheel, color, frost, iris or any other optical effect as well known in the art. Effect 62 may comprise a gobo wheel, all or any of which may be individually or cooperatively controlled. In further embodiments the gobo wheel may not be a complete circle, but may be a portion of a disc, or a flag so as to save space and provide a more limited number of gobo options. The gobo patterns may be of any shape and may include colored images or transparencies. In yet further embodiments individual gobo patterns may be further rotated about their axes by supplementary motors in order to provide a moving rotating image. Such rotating gobo wheels are well known in the art.

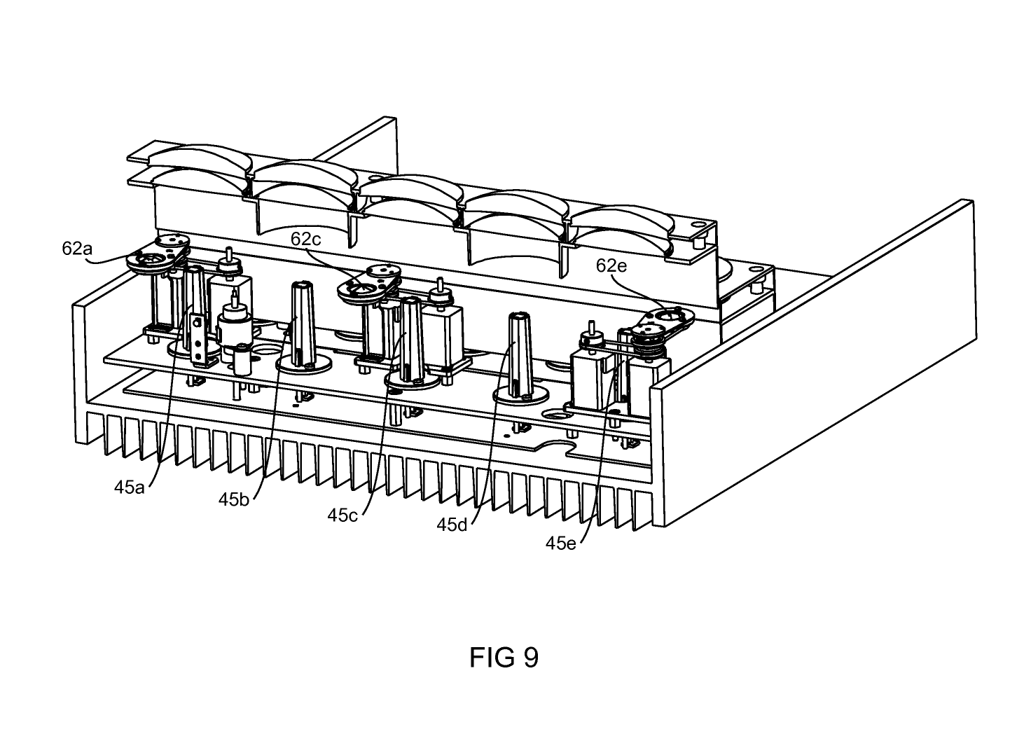

FIG. 9 illustrates a light module with single row of light sub-modules in an embodiment of the invention. In this figure a row of five light-emitting sub-modules 45a, 45b, 45c, 45d, and 45e is shown. Three of the light emitting sub-modules, 45a, 45c, and 45e are fitted with effects 62a, 62c, and 62e. Two of the light-emitting sub-modules 45b, and 45d have no effects. In further embodiments any number or combination of light-emitting sub-modules may be fitted with effects systems, and those effects systems may be of the same or differing type. For example some light-emitting sub-modules may be fitted with prism effects while other are fitted with gobo effects. Additionally some rows of light sub-modules may be fitted with effects while other rows are not.

In some embodiments each of the effects systems 62a, 62c, and 62e may be individually and separately controlled such that only selected light-emitting sub-modules are using an effect as desired by the operator.

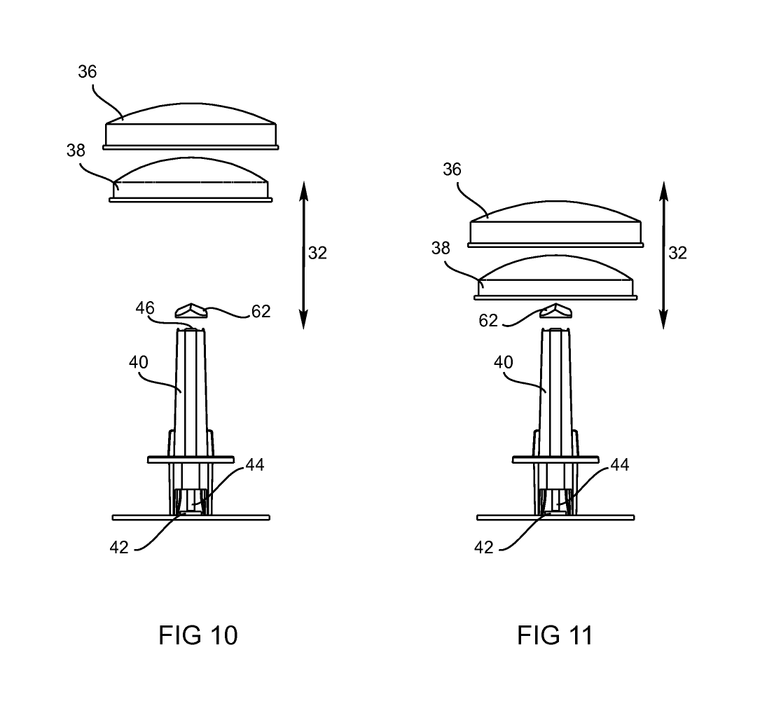

FIGS. 10 and 11 illustrate the operation of the optical system in an embodiment of the invention when fitted with effect 62. A light-emitting sub-module of the system comprises an LED 42, which may include a primary optic, is mounted on substrate 43. LED 42 may contain a single color die or may contain multiple dies, each of which may be of differing colors. The light output from the dies in LED 42 enters light integrator optic 44 contained within protective sleeve 40. Light integrator 44 may be a device utilizing internal reflection so as to collect, homogenize and constrain and conduct the light to exit port 46. Light integrator 44 may be a hollow tube with a reflective inner surface such that light impinging into the entry port may be reflected multiple times along the tube before leaving at the exit port 46. Light integrator 44 may be a square tube, a hexagonal tube, a heptagonal tube, an octagonal tube, a circular tube, or a tube of any other cross section. In a further embodiment light integrator 44 may be a solid rod constructed of glass, transparent plastic or other optically transparent material where the reflection of the incident light beam within the rod is due to total internal reflection (TIR) from the interface between the material of the rod and the surrounding air. The integrating rod may a square rod, a hexagonal rod, a heptagonal rod, an octagonal rod, a circular rod, or a rod of any other cross section.

The light exiting integrator 44 will be well homogenized with all the colors of LED 42 mixed together into a single colored light beam. In various embodiments of the invention each LED emitter 42 may comprise a single LED die of a single color or a group of LED dies of the same or differing colors. For example in one embodiment LED emitter 42 may comprise one each of a Red, Green, Blue and White LED die or one each of a Red, Green, Blue and Amber LED die. In further embodiments LED emitter 42 may comprise a single LED chip or package while in yet further embodiments LED emitter 42 may comprise multiple LED chips or packages either under a single primary optic or each package with its own primary optic. In some embodiments these LED die(s) may be paired with optical lens element(s) as part of the LED light-emitting sub-module. In a further embodiment LED emitter 42 may comprise more than four colors of LEDs. For example seven colors may be used, one each of a Red, Green, Blue, White, Amber, Cyan, and Deep Blue/UV LED die.

Integrator 44 may advantageously have an aspect ratio where its length is much greater than its diameter. The greater the ratio between length and diameter, the better the resultant mixing and homogenization will be. Integrator 44 may be enclosed in a tube or sleeve 40 that provides mechanical protection against damage, scratches, and dust.

In further embodiments the light integrator 44, whether solid or hollow, and with any number of sides, may have entry ports and exit ports that differ in shape. For example, a square entry port and an octagonal exit port 46. Further light integrator 44 may have sides which are tapered so that the entrance aperture is smaller than the exit aperture. The advantage of such a structure is that the divergence angle of light exiting the integrator 44 at exit port 46 will be smaller than the divergence angle for light entering the integrator 44. The combination of a smaller divergence angle from a larger aperture serves to conserve the etendue of the system. Thus a tapered integrator 44 may provide similar functionality to a condensing optical system.

Light exiting integrator 44 is directed towards and through effect 62 and then through first lens 36 and second lens 38 that serve to further control the angle of the emitted light beam. First lens 36 and second lens 38 may be moved as a pair towards and away from light integrator 44 as described above in the direction along the optical axis of the system as shown by arrow 32. In the position shown in FIG. 6 where first lens 36 and second lens 38 are at their furthest separation from the light-emitting sub-module and the exit 46 of integrator 44 the emitted light beam will have a narrow beam angle. In the position shown in FIG. 7 where first lens 36 and second lens 38 are at their closest distance to the light-emitting sub-module and the exit 46 of integrator 44 the emitted light beam will have a wide beam angle. Intermediate positions of the lenses 36 and 38 with respect to exit 46 of integrator 44 will provide intermediate beam angles. In one embodiment of the invention, the range of beam angles from the system may be adjusted from 4° to 50°.

The introduction of effect 62 may limit how close first lens 36 and second lens 38 may move towards integrator 44. This, in turn, may limit the maximum output angle of the optical system when effect 62 is being utilized.

Although the embodiments illustrated herein show specific numbers of light-emitting modules and corresponding sub-modules in practice the invention is not so limited and any number of light-emitting modules and corresponding sub-modules may be mounted with any number of effects systems to form a luminaire. In any of the possible arrangements, each of the rows of light-emitting sub-modules may be capable of independent beam angle control. Further, the light-emitting modules and sub-modules may be arranged in any shape or layout. Embodiments such as linear, round, rectangular and square arrangements may be commonly used, but any arrangement shape may be used.

While the disclosure has been described with respect to a limited number of embodiments, those skilled in the art, having benefit of this disclosure, will appreciate that other embodiments may be devised which do not depart from the scope of the disclosure as disclosed herein. The disclosure has been described in detail, it should be understood that various changes, substitutions and alterations can be made hereto without departing from the spirit and scope of the disclosure.

What is claimed is:

1. A luminaire comprising:
a carrier housing into which are mounted
a plurality of light emitting modules each fitted with
a plurality of beam control systems each of which alter the beam angle of a light emitting module where the plurality of light emitting beam control systems are independently controlled.

2. The luminaire of claim 1 in which each module further comprises a plurality of LED sub-modules.

3. The luminaire of claim 2 where the first light-emitting module's LED sub-modules are arranged in a linear row.

4. The luminaire of claim 4 where the second light-emitting module's LED sub-modules are arranged in a linear row.

5. The luminaire of claim 4 where a third second light-emitting module's LED sub-modules are arranged in a linear row.

6. The luminaire of claim 5 where the light emitting modules each include the same number of LED Sub-modules.

7. The luminaire of claim 6 where the light emitting modules mounted in the carrier in parallel to each other forming a rectangular array.

8. The luminaire of claim 5 where the light emitting modules have different number of LED Submodules

9. The luminaire of claim 2 where a plurality of the LED sub-module contains four colors of LEDs.

10. The luminaire of claim 2 where each light-emitting module contains five or more colors of LEDs.
